(19) United States
(12) Patent Application Publication
(10) Pub. No.: US 2008/0281741 A1
(43) Pub. Date: Nov. 13, 2008

(54) DATA NETWORK ASSOCIATION FOR FINANCIAL SERVICES

(76) Inventor: Richard L. Hyde, Newmarket (CA)

Correspondence Address: PATTERSON & SHERIDAN, L.L.P., 3040 POST OAK BOULEVARD, SUITE 1500, HOUSTON, TX, 77056, US

(21) Appl. No.: 12/117,103

(22) Filed: May 8, 2008

Related U.S. Application Data
(60) Provisional application No. 60/928,074, filed on May 8, 2007.

(51) Int. Cl. G06Q 40/00

(52) U.S. Cl. 705/35

(57) ABSTRACT

A system is provided for consolidating financial information to allow multiple advisors to advise a customer with respect to financial products and/or services. Account data from a plurality of financial institutions is brought together in a computer implemented front end program having network access to each of the accounts. Each advisor can access this single environment. The customer has control over what type of account data each advisor can view, edit or transact with.

### CROSS-REFERENCE TO RELATED APPLICATIONS

This application claims benefit of U.S. provisional patent application Ser. No. 60/928,074, filed May 8, 2007, which is herein incorporated by reference.

### FIELD OF THE INVENTION

The invention relates to systems allowing for integration of financial services data from a plurality of financial institutions.

### BACKGROUND OF THE INVENTION

Many changes have occurred in the financial services sector. In the 1980's the large enterprises and the financial institutions (FIs) were in the controlling seat with large captive sales forces. The early 1990's saw the emergence of independent distributors and the financial advisors were in control. The late 1990's saw the emergence of the Internet and with that came systems and service-offerings that put the investor at the helm. Between 2002 and 2004, various FIs and distribution networks started forming alliances which led to the consolidation during 2005-2007 timeframe. These shifts have changed which players have been at the “centre of the universe” in financial services and have affected how financial products are marketed to customers.

In order to meet customer requirements and to bring costs down, a wave of consolidation is sweeping the financial industry. Banks are now offering insurance services and insurance companies are now also offering banking services. In many scenarios, the consolidation is via acquisitions of smaller market players or merger of larger ones. Although the consolidation resulting from mergers and acquisitions in the financial industry has brought many diverse services under one roof, within each singular large financial institution, the different departments are still like silos. Since there is little or no back-end integration, the customer almost has to “open a new account” from one department to another, even though the customer may already be using one or more services at the same FI.

“Big Box” retail concepts have emerged, e.g. Costco stores, where users are a captive audience and are offered a wide variety of consumer products, almost anything that they would need in their normal day to day life. FIs have also come around to the idea of one-stop shopping for financial products. However, the balkanization of back-end systems has made this goal impractical for FIs to implement.

Today's financial services customer has many different financial needs—banking, insurance, investment management, retirement planning, estate management, living will, etc. Today many of these services are provided in a very manual fashion by many different companies all trying to fulfill as many of the services as possible. Thus an individual usually deals with several such companies in order to fulfill all his needs.

However, balkanization in the industry has meant that no one institution is capable of looking out for the customer's big picture—or helping the customer to achieve financial goals and meet their needs over different life-stages and life-events.

At present, there are no known systems offering an end-to-end solution for all of the financial services needed by an individual whether they are considered high net-worth or otherwise. Therefore the customer is forced to deal with more than one FI to get all of the required services. In some cases, these institutions may also be competing with each other to get a bigger share of the customer's portfolio, at times putting the customer in a conflicting situation.

The user experience of procuring and managing financial services needs to be simplified. The diverse and silo backend systems need to be able to communicate with each other to present a holistic view of the client's needs, and to allow the customer's portfolio to be matched to the customer's changing life-stages and life-events and allow him/her to take advantage of more integrated services.

Therefore a need exists for a new approach to financial services data integration, which offers a unified platform for consolidation acting as an umbrella layer on top of the old back-office systems. Additionally the approach should also be able to present a holistic view of the customer needs and services, while being flexible to adapt with the changes in market trends that are being impacted by factors like globalization of the economies, the rapid pace to technology adoption, and a more sophisticated and financially-savvy consumer. Also a high priority requirement for such an approach is ease to implement and on going maintenance when switching from one player to another acting as the “centre of the universe”.

The changing trends require new solutions since the players in the central role change with time. Thus who is at the “centre of the universe” impacts the system design, and many times the system becomes obsolete once a new player becomes the “center of the universe”. Considerable investments in the backend systems thus become diminished over-night as new alliances are formed or as further consolidation brings the competing players under one umbrella. Therefore, a new front-end system design that can adapt with the changing trends is required such that substantial investments in the backend systems are given a new lease on life by re-organizing the constituent elements to meet the needs of the changing trends.

### SUMMARY OF THE INVENTION

According to a first aspect of the invention, a system is provided for consolidating financial information to allow multiple advisors to advise a customer with respect to financial products and/or services. The customer has accounts at a plurality of financial institutions. The system uses a computer implemented front end program which has network access to each of the accounts at the plurality of financial institutions. The program provides a single environment for advisors. Permissions are associated with data in each of the accounts. The program allows the customer to set permissions for each of the customer's advisors with respect to each type of data in the accounts, such that each advisor is only allowed to view and/or edit and/or transact with permitted data.

The permission can be temporary or time-limited. The permission can prescribe limited functionality with respect to the particular type of data. That is, the permission can be a limited permission, allowing the advisor, for instance, just to view the data, or just to view current data.

The program preferably associates the customer with a profile, which has demographic information about the customer and/or the customer's household. Advisors can preferably group data on a plurality of customers by elements in the customers' profiles. Advisors can preferably market a financial product or service to a plurality of customers by grouping the customers by elements in their respective profiles. Various kinds of information can be in the profile. One type of information that may be present is a risk tolerance preference that has been given by the customer (or derived from other information or transaction history). The program may use the risk tolerance preference to alert advisors when a proposed transaction exceeds the customer's risk tolerance preference.

The program may allow the customer to link associated accounts to the customer's accounts. For instance, spousal accounts may be linked, or household accounts may be linked or grouped together.

Preferably, the program allows a great deal of latitude for various parameters to be changed over time, such as:
Permissions;
Profiles;
Advisors (and advisor relationships to particular customers).

Preferably, the program allows advisors to set or change permissions with respect to other advisors. For instance, advisors may be allowed to designate deputy or subordinate advisors (and grant them limited permissions to deal with the information that the advisors can deal with).

Preferably, the program, in addition to having permissions that are individually set by account and customer, has global permissions for advisors with respect to certain steps or transactions. For instance, advisors may have permission to execute certain kinds of trades (according to their license or regulatory status). The program may have constraints to prevent advisors from transacting in off-book matters.

Preferably, the program has various reporting options. The program may allow reports to be generated with respect to a customer's current or historical account information. Advisors may also be able to generate reports on groups of customers. Preferably, the program provides access to a history and archive of financial transactions, communications, and information associated with an account or an advisor.

According to a second aspect of the invention, a system is provided for a first advisor and a second advisor to share access to a customer's account information to allow them to advise the customer with respect to financial products and/or services. The system uses a computer implemented front end program having network access to each of the customer's accounts at the plurality of financial institutions. The program provides a single environment shared by the first and second advisor. Permissions are associated with data in each of the accounts. The program allows the customer to set permissions separately for the first and second advisor with respect to each type of data in the accounts, such that the first advisor and the second advisor have different views of the same account information.

According to a third aspect of the invention, a system is provided for allowing financial institutions to compete for customers by allowing their advisors to access pooled information from a plurality of customer accounts at the financial institutions. The system uses a computer implemented front end program having network access to each of the accounts at the financial institutions. The program provides a single environment for advisors. Permissions are associated with data in each of the accounts. The program allows a customer associated with an account to set permissions for each of the advisors with respect to each type of data in the account, such that each advisor is only allowed to view and/or edit and/or transact with permitted data.

According to a fourth aspect of the invention, a system is provided for consolidating financial information to allow a primary user to advise on or transact with financial products and/or services on behalf of a second user. The financial information is stored at a plurality of financial institutions. The system uses a computer implemented front end program having network access to the financial information at the plurality of financial institutions. The program provides a single environment to consult and transact with the financial information. Permissions are associated with the financial information. The program allows the second user to set permissions for the primary user, such that the primary user is only allowed to view and/or edit and/or transact with permitted information. The system is preferably flexible to allow the primary user and the second user to switch or change roles.

According to a fifth aspect of the invention, a system is provided for consolidating customer account information to allow multiple advisors or representatives to advise a customer with respect to new products and/or services related to the customer account information. The customer has accounts at a plurality of institutions. The system uses a computer implemented front end program having network access to the customer account information at the plurality of institutions. The program provides a single environment for the advisors or representatives. Permissions are associated with data in each of the accounts. The program allows the customer to set permissions for each of the advisors or representatives with respect to each type of data in the accounts, such that each advisor or representative is only allowed to view and/or edit and/or transact with permitted data.

### BRIEF DESCRIPTION OF THE FIGURES

FIG. 1 is a diagram of a sample data network association in linked connection with various users and advisors.

FIG. 2 is a diagram of a sample matrix of types of data to which access may be granted.

FIG. 3 is a diagram illustrating sample access control and permissions relationships of various users to specific data.

FIG. 4 is a diagram illustrating different users in a relationship that can change over time.

FIG. 5 is a diagram illustrating a possible application of the data for campaign management.

FIG. 6 is a flow diagram of a sample transaction checking permissions and profile variables.

FIG. 7 is a flow diagram for creating an associated account.

FIG. 8 is a flow diagram of a sample campaign management workflow.

### DETAILED DESCRIPTION OF THE FIGURES

The Data Network Association is a system that is composed of either hardware, software or applications meant to provide a holistic view and/or a total financial picture of the diverse financial services offered by the many silo facets of an enterprise/FI and the various products/services that the investor is utilizing. The system provides a personalized solution providing a consolidated and holistic view of the client needs e.g. banking, insurance, investment management, retirement planning, estate management, living will, etc. The system provides a holistic platform to market and sell all of the financial services and products that the FI offers by integrating the various silo workflows and fulfillment processes.

Preferably, the major users of the systems may be but not limited to the following roles:
Manufacturer (i.e. the maker or originator of a financial product)
Distributor (i.e. a seller or distributor of the financial product)
Advisor (i.e. someone that advises about the ramifications of financial products, but does not necessarily sell them)
Investor (i.e. the customer, consumer, buyer of the financial product)

Preferably, there may be further sub-groups within each one of the above listed such that each individual user may have its own unique set of capabilities (e.g. view) based on their role and permissions. The preferred embodiment of the method and system described here is exemplary and the invention is not limited to this scenario but incorporates all possibilities and variations that are obvious to the ones skilled in the art.

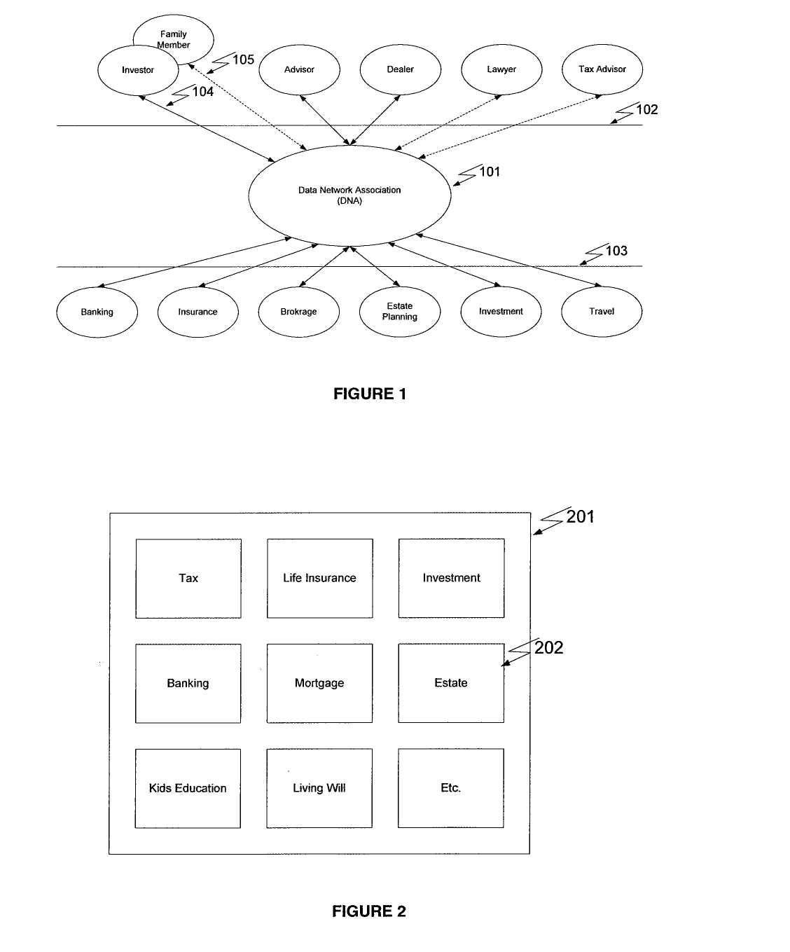

FIG. 1 depicts the basic principle of the invention. The Data Network Association (DNA) 101 is the enabling mechanism that consolidates the various backend data systems depicted by ovals below the line 103 of one or more financial institutions and the ovals above the line 102 depict the users of the system. The solid lines e.g. 104 represent a more permanent relationship while the broken line e.g. 105 represents a limited relationship.

Providing an umbrella layer, by front-end consolidation, the system may provide capabilities for the users to have a holistic view to the various services and product offerings. While at the same time the financial institution may also be able to offer a broader portfolio of integrated services.

In the preferred embodiment the system may be fully automated and may run with minimal user input. The level of automation may be further dependent on the investor profile and the advisor, such that it may be configurable from one customer to another or may be defined globally for either all customers or a sub-set thereof. Preferably, the system may also provide a GUI or other such user friendly mechanism in the software for example access via a web browser or a specifically compiled application for displaying and changing the settings or performing financial transactions. Preferably, the methods may also interface with other technologies for example being part of an enterprise portal or an intranet.

Preferably there may be default settings for the various options that may be changed by the system administrator to have a global effect or changed by the individual user for their own account employing this interface to suite their specific needs. There may be embodiments that incorporate various combinations of the above mentioned in any given order.

FIG. 2 shows one embodiment; the DNA Drawer 201 where system resources and product offerings 202 are arranged in a matrix and each user's capabilities and view are constructed by combining different elements from the matrix based on who the user is and then granting access to these individual elements. Preferably, the matrix may have two or more dimensions depending on the number of elements and their possible combinations.

The system manages the Dynamic User Profile and adjusts the system access and behavior accordingly. Each element in the matrix may represent a unique system resource or a product offering or a collection of other resources.

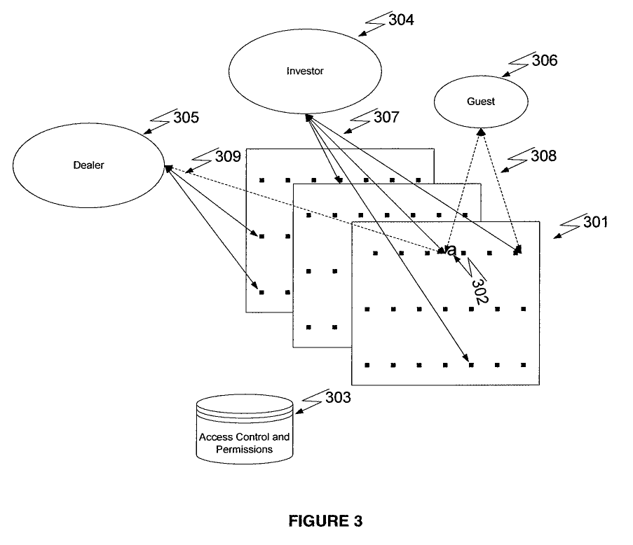

FIG. 3 shows the different systems and their associated resources arranged in a three dimensional matrix 301 where the elements of the matrix e.g. “a” 302 represent the system resources or product offerings. The different users e.g. the Investor 304 and the Dealer 305 each have a unique view which is governed by the Access Control and Permissions database 303. One system resource “a” 302 for example may represent the Investor's portfolio. The solid lines e.g. 307 represent a more permanent relationship while the broken lines e.g. 308 and 309 represent a temporary or a limited relationship/access to the elements of the matrix 301. The role of a Guest 306 represents a user who may have been granted temporary permissions by another user, e.g. the Investor 304. Similarly the Dealer 305 may have been granted a temporary permission to view the Investor's portfolio; the temporary access being represented by the broken line 309. The system provides the ability to grant limited access and permissions of the account details to other individuals including family members, advisors, third party professionals, sponsoring financial institute etc. This limited access permission is granted on either a limited time or limited view, or limited capabilities basis or a combination thereof. Additionally it also provides a history and an archive of all financial transactions, communications, documents and information exchanged between parties. The system provides a mechanism for an automated gating process for financial transactions such that they are based on a client's permissions and profile matching the target financial commodity.

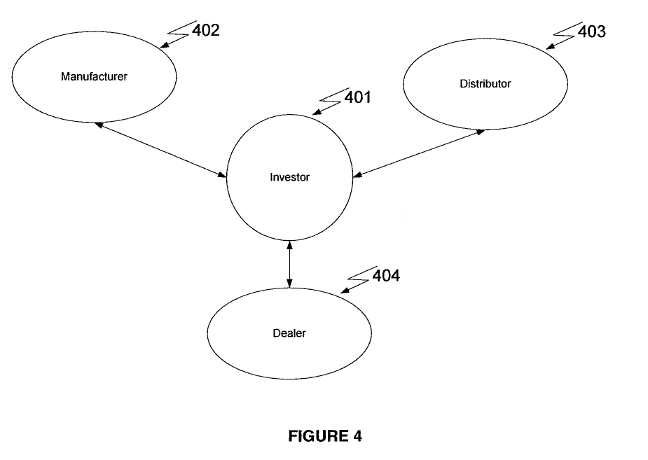

The diagram in FIG. 4 shows the different users and their relationship to the system defined by the trends of the time. In today's financial markets, the Investor 401 might be considered the “center of the universe”. Thus the backend systems are implemented such that they treat the Investor 401 as core. As time goes by and new trends emerge it is quite possible that the Dealer 404 may end up being the “center of the universe”. If the designed and implemented systems are “rigid” in terms of the different users and their inter-relationships there is a definite risk of the whole system becoming obsolete since it may not be able to cater to the new needs. The system provides a mechanism based on permissions and access control that enables the changing of players to suit the changing trends in the market place; i.e. the player at the “centre of the universe” can be changed and the services, products, views etc. then reflect this change automatically.

The method and process defined here represent a fundamentally new approach to front-end system design where the inter-relationships of the users are flexible. Thus by redefining the inter-relationships in a different way, any user may now interchangeably be at the “center of the universe” and the systems and their offered resources may now be reorganized in a new combination suitable to the current landscape i.e. which user is in the central role.

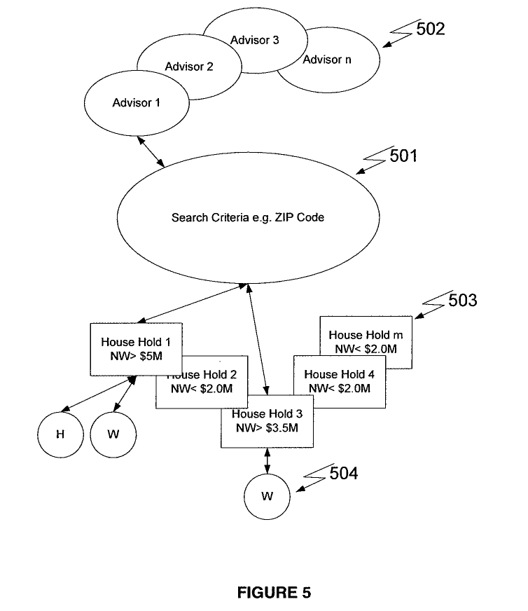

The Data Network Association also allows for the generation and management of campaigns. FIG. 5 depicts one such scenario where the campaign is based on a particular area say defined by a ZIP code or city limits and the Household net worth (NW) greater than $2.0 million. There may be other criteria that can be layered on top e.g. but not limited to risk tolerance, marital status, children and their ages, professional or in business, sports preferences, age, gender, health factors etc.

In this exemplary campaign, different users can have different views of the data. For example, the enterprise/FI may see all the advisors 502 associated with that particular ZIP code 501 and all of their associated investors 503; whereas an individual advisor e.g. Advisor 1 may only see the household assigned to him (Household 1 and Household 3) and the investors within those households e.g. “W” 504 in Household 3.

Additionally the system provides for report generation, group communications, notifications based on user preferences e.g. account statement in a PDF file sent via e-mail or a URL link sent by e-mail to access the statement or a printed statement sent in regular mail. Preferably, the communications from the campaign may be sent to the households based on their individual preferences as defined in the user profile. For example some users may opt for a PDF file to be sent via e-mail, others may prefer to get a link via an e-mail and yet others may want to get printed material by regular mail. This list is only exemplary and is not meant to be exhaustive.

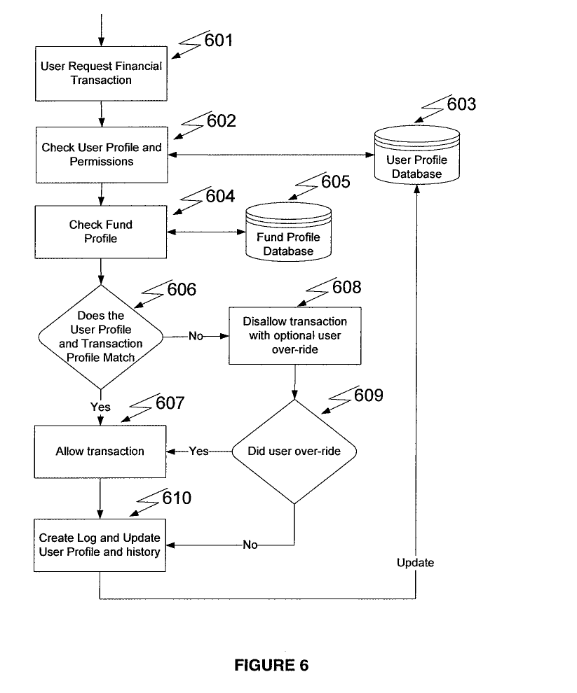

FIG. 6 shows one embodiment where the user requests a transaction, such as the purchase of a particular “Fund” for investment purposes. The system compares the User Profile and the Fund Profile to determine if the transaction should proceed.

In FIG. 6 the user requests a transaction 601 e.g. purchase of “Mutual Fund A”. The system checks for the user profile and permissions 602 in the User Profile Database 603 and it also checks the Mutual Fund A profile 604 in the Fund Profile Database 605, to see if the instrument being purchased has an associated label for risk (e.g. “low”, “medium” and “high”). Check if the user profile and the risk label match 606. For example if the user profile has the risk tolerance set to “medium”; and the risk label of the Mutual Fund A is “high”, then the system will disallow the transaction 608. If the user profile and the transaction profile match, then the system allows for the transaction to be processed 607. The system may provide for a user over-ride 608; check if the user opted for the over-ride 609. If the user opted for the over-ride allow the transaction to be processed 607. If the user did not opt for the over-ride, the system disallows the transaction. The system creates a log and updates the user profile and history accordingly 610 and stores the log and history in the User Profile Database 603. The implementation may have several variations e.g. global limits defined by the FIs, and individual thresholds defined by the user profiles.

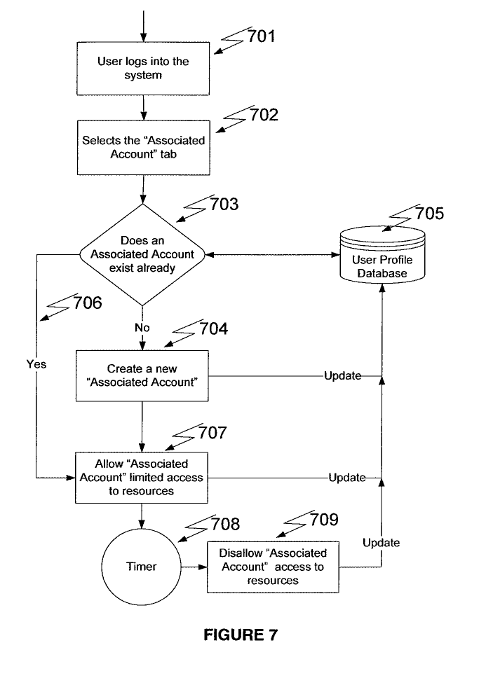

FIG. 7 shows yet another embodiment where the user grants a time limited access to an associated user. For example an investor may want to grant access to his Stock Portfolio to the Tax Advisor for, say a one week period. The permissions to the associated account expire after the defined period is over.

User logs into the system 701, user selects the “Associated Accounts” tab 702 or other such mechanism to check if an associated account already exists 703 by looking at the user profile that is stored in the User Profile Database 705. If the Associated Account does not exist, the user is given the option to create one 704 and the user profile is updated in the User Profile Database 705. Once Associated Account is created, allow it limited access to resources 707 (e.g. by employing a graphical user interface offering various options from drop down menus to define the limits of the access) and then update the user profile. There may be a counter or a timer 709 that monitors the Associated Accounts and disallows access to resources 710 after the timer or the counter has reached a limit. For example if limited access was granted for a week, after the passage of one week disable Associated Account or if the limited access allowed 5 logins, disallow access on the 6th login.

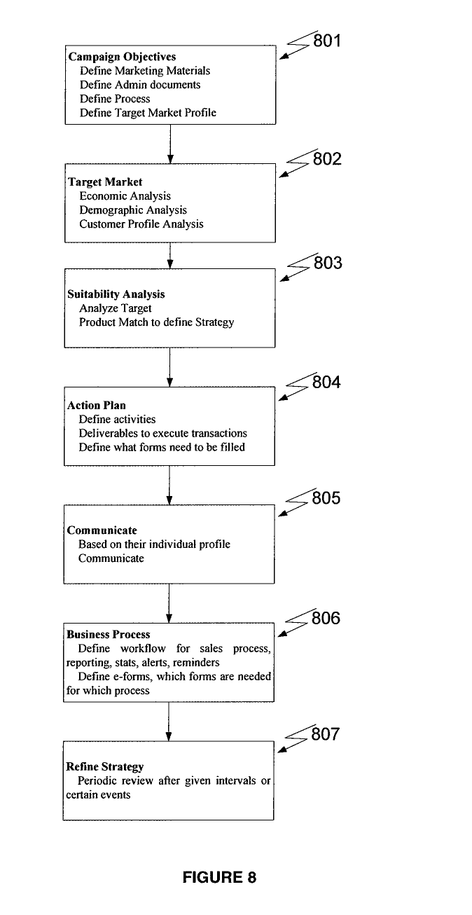

The system and method defined in this invention also provides campaign management capabilities for up-selling, or cross-product promotion or identifying new opportunities via customer surveys. The system offers work-flow management for the FIs to launch sophisticated campaigns by matching client profiles/permissions with the service/product offerings. The typical workflow of the preferred embodiment may be as shown in FIG. 8.

An enterprise or FI may define the Campaign Objectives by defining Marketing Materials, Administrative documents, Process definition and Target Market profile 801 and defining the Target Market by conducting an Economic Analysis, a Demographic Analysis, or a Customer Profile Analysis to yield a Target Market 802. Suitability Analysis may be next and preferably may include Analysis of the Target Market to find Product Match best suited for that segment to define the Strategy 803. This may be followed by an Action Plan which in turn may constitute the definition of activities and deliverables to execute the Action Plan (e.g. transactions both buy and/or sell) and definition of what forms need to be filled in order to execute transactions 804. The next step may be communication with the Target Market based on their individual profile 805 e.g. certain customers are sent e-mails, others are sent printed materials in regular mail.

The Workflow may then also define a Business Process which may include a definition of the sub-workflow for the sales process, reporting, statistics, alerts, reminders etc. and defining of the e-forms and detailing which forms are to be filled for which process 806. The last step may be a periodic review to refine the strategy over a period of time especially after given intervals e.g. at the end of every year or after certain events e.g. birth of a child or change in job status 807.

In another embodiment of the exemplary campaign management workflow, the FI/enterprise may define broadly the campaign goals to match the corporate objectives while the advisors may then define more specifically directed campaigns to suit their client's specific demographic needs. The system and method described here also provides for mechanisms for grouping users based on a criterion (e.g. all married or divorced clients) and then allows the advisor to create and manage a campaign to target that particular group with financial products/services specifically designed for their specific needs. To take another example, an FI may have a campaign designed to target households with combined incomes of over US$100,000; while a particular advisor who serves a relatively large base of customers may split this campaign in two segments one for households with combined income between US$100,000 and US$150,000 and another for households with combined income in excess of US$150,000; thus having a different action plan and sales strategy to approach each segment with a varied products and services portfolio.

There may be yet other embodiments, for example one where the enterprise/FI defines the entire campaign with no changes or modifications possible by any other parties. In yet another embodiment, the FI may only define the campaign loosely with broad criteria giving the users the capability and independence to further refine and modify the campaign to suit say geographical needs e.g. compliance with State laws or variation of product offerings from urban to rural areas.

The campaigns may range over multiple silo offerings from different financial segments either all within the same FI/enterprise or in cooperation with partners. For example a campaign “Know Your Customer” may take into account all customers whose personal profile is incomplete in some or all of the following but not limited to banking, insurance, investment planning and management, retirement planning, estate management, living will, etc. when targeting a certain demographic.

The campaigns may have a further refinement of being able to capture updates from the customers based on verbal input or written input depending on different situations e.g. a phone call as opposed to a written request to gather information.

The campaigns may further be either date driven or activity driven or event driven and may have mechanisms for reporting, alerts, reminders etc.

The system and method described in this application especially in the preferred embodiment is for the financial services sector, but may be applicable to other industries where different business silos exist within the same enterprise due to consolidation which may have come about as a result of acquisitions, for example companies offering landline phone services, cell phone services, broad-band internet access, cable/digital cable TV or IPTV etc.

The examples noted here are only for illustrative purposes and there may be further implementation embodiments possible with a different set of components or utilizing a different set of technologies e.g. either Microsoft .Net or Java. While several embodiments are described, there is no intent to limit the disclosure to the embodiment or embodiments disclosed herein. On the contrary, the intent is to cover all alternatives, modifications, and equivalents obvious to the ones familiar with the art. Methods described herein are likewise exemplary, and it is not intended to limit the invention to the specific sequences or combinations described. Likewise, steps may be omitted or combined, as appropriate, given the knowledge and judgement of those skilled in the art.

What is claimed is:

1. A system for consolidating financial information to allow multiple advisors to advise a customer with respect to financial products and/or services, the customer having accounts at a plurality of financial institutions, the system comprising:
a computer implemented front end program having network access to each of the accounts at the plurality of financial institutions, the program providing a single environment for advisors;
the program having permissions associated with data in each of the accounts;
the program allowing the customer to set permissions for each of the customer's advisors with respect to each type of data in the accounts, such that each advisor is only allowed to view and/or edit and/or transact with permitted data.

2. The system of claim 1, wherein permission can be temporary or time-limited.

3. The system of claim 1, wherein each permission can prescribe limited functionality with respect to the particular type of data.

4. The system of claim 1, wherein the program associates the customer with a profile, the profile having demographic information about the customer and/or the customer's household.

5. The system of claim 4, wherein the program allows advisors to group data on a plurality of customers by elements in the customers' profiles.

6. The system of claim 4, wherein the program allows advisors to market a financial product or service to a plurality of customers by grouping the customers by elements in their respective profiles.

7. The system of claim 4, wherein the profile includes a risk tolerance preference and wherein the program alerts advisors when a proposed transaction exceeds the customer's risk tolerance preference.

8. The system of claim 1, wherein the program allows the customer to link associated accounts to the customer's accounts.

9. The system of claim 1, wherein the program allows household accounts to be grouped together.

10. The system of claim 1, wherein the program allows permissions to be changed.

11. The system of claim 1, wherein the program allows profiles to be changed.

12. The system of claim 1, wherein the program allows advisors to be changed.

13. The system of claim 1, wherein the program allows advisors to set or change permissions with respect to other advisors.

14. The system of claim 1, wherein the program has global permissions for advisors with respect to certain steps or transactions.

15. The system of claim 1, wherein the program prevents advisors from transacting in off-book matters.

16. The system of claim 1, wherein the program allows reports to be generated with respect to a customer's current or historical account information.

17. The system of claim 1, wherein the program allows an advisor to generate reports with respect to account information from a group of customers.

18. The system of claim 1, wherein the program provides access to a history and archive of financial transactions, communications, and information associated with an account or an advisor.

19. A system for a first advisor and a second advisor to share access to a customer's account information to advise the customer with respect to financial products and/or services, the customer having accounts at a plurality of financial institutions, the system comprising:
a computer implemented front end program having network access to each of the accounts at the plurality of financial institutions, the program providing a single environment shared by the first and second advisor;
the program having permissions associated with data in each of the accounts;
the program allowing the customer to set permissions separately for the first and second advisor with respect to each type of data in the accounts, such that the first advisor and the second advisor have different views of the same account information.

20. A system for allowing financial institutions to compete for customers by allowing their advisors to access pooled information from a plurality of customer accounts at the financial institutions, the system comprising:
a computer implemented front end program having network access to each of the accounts at the financial institutions, the program providing a single environment for advisors;
the program having permissions associated with data in each of the accounts;
the program allowing a customer associated with an account to set permissions for each of the advisors with respect to each type of data in the account, such that each advisor is only allowed to view and/or edit and/or transact with permitted data.

21. A system for consolidating financial information to allow a primary user to advise on or transact with financial products and/or services on behalf of a second user, the financial information being stored at a plurality of financial institutions, the system comprising:
a computer implemented front end program having network access to the financial information at the plurality of financial institutions, the program providing a single environment to consult and transact with the financial information;
the program having permissions associated with the financial information;
the program allowing the second user to set permissions for the primary user, such that the primary user is only allowed to view and/or edit and/or transact with permitted information.

22. The system of claim 21, wherein the program further allows the primary user and the second user to switch or change roles.

23. A system for consolidating customer account information to allow multiple advisors or representatives to advise a customer with respect to new products and/or services related to the customer account information, the customer having accounts at a plurality of institutions, the system comprising:
a computer implemented front end program having network access to the customer account information at the plurality of institutions, the program providing a single environment for the advisors or representatives;
the program having permissions associated with data in each of the accounts;
the program allowing the customer to set permissions for each of the advisors or representatives with respect to each type of data in the accounts, such that each advisor or representative is only allowed to view and/or edit and/or transact with permitted data.
